(19) United States
(12) Patent Application Publication
(10) Pub. No.: US 2004/0220836 A1
(43) Pub. Date: Nov. 4, 2004

(54) Healthcare information management system

(76) Inventors: Niall Doherty, Berwyn, PA (US); Michael Brensinger, Sinking Spring, PA (US)

Correspondence Address: Alexander J. Burke, Intellectual Property Department, 5th Floor, 170 Wood Avenue South, Iselin, NJ, 08830, US

(21) Appl. No.: 10/794,979

(22) Filed: Mar. 5, 2004

Related U.S. Application Data
(60) Provisional application No. 60/452,909, filed on Mar. 7, 2003.

(51) Int. Cl. G06F 17/60

(52) U.S. Cl. 705/3

(57) ABSTRACT

Certain exemplary embodiments provide a healthcare information management system, comprising: an interface processor for automatically electronically acquiring information for use in identifying completion status of a plurality of electronic patient healthcare records of a corresponding plurality of different patients; a data analyzer for analyzing said acquired information to derive data indicating, (a) a first number of electronic patient healthcare records to be updated in response to events occurring during a predetermined time period, and (b) status of a second number of said electronic patient healthcare records as being at least one of, (i) complete and (ii) incomplete; and an output processor for processing said derived data to be suitable for communication.

### CROSS-REFERENCE TO RELATED APPLICATIONS

This application claims priority to pending provisional application Ser. No. 60/452,909 (Applicant Docket No. 2003P03426US), filed 7 Mar. 2003.

### BACKGROUND

Existing applications provide discrete components supporting healthcare information management. However existing systems lack integration of components and require multiple often incompatible systems requiring support from corresponding multiple vendors and fail to provide comprehensive clinical and management decision support. Such systems also typically require substantial manual intervention to achieve desired results. Further, existing components are from a fragmented array of vendors offering a bewildering multiplicity of user interfaces. These components lack desired comprehensive decision making and performance management capabilities.

### SUMMARY

Certain exemplary embodiments provide a healthcare information management system, comprising: an interface processor for automatically electronically acquiring information for use in identifying completion status of a plurality of electronic patient healthcare records of a corresponding plurality of different patients; a data analyzer for analyzing the acquired information to derive data indicating, (a) a first number of electronic patient healthcare records to be updated in response to events occurring during a predetermined time period, and (b) status of a second number of the electronic patient healthcare records as being at least one of, (i) complete and (ii) incomplete; and an output processor for processing the derived data to be suitable for communication.

### BRIEF DESCRIPTION OF THE DRAWINGS

A wide array of potential embodiments can be better understood through the following detailed description and the accompanying drawings in which:

FIG. 1 is a flow chart of an exemplary embodiment of a method 1000; and

FIG. 2 is a block diagram of an exemplary embodiment of a system 2000;

FIG. 3 is a flow chart of an exemplary embodiment of a method 3000;

FIG. 4 is a block diagram of an exemplary embodiment of an information device 4000; and

FIG. 5 is a model of an exemplary embodiment of a user interface 5000.

### DEFINITIONS

When the following terms are used herein, the accompanying definitions apply:

abstract—to review a chart, identify information fitting predetermined criteria, and enter the identified information (or a code representative of the identified information) into a repository.

acquire—obtain, import, and/or receive.

alert—an electrical, electronic, or mechanical device and/or display that serves to advise of a condition by means of a sound or signal.

analyzer—a processor.

application—instructions for controlling a processor.

assembly—the act of gathering related records into a group.

automatically—acting or operating in a manner essentially independent of external influence or control. For example, an automatic light switch can turn on upon “seeing” a person in its view, without the person manually operating the light switch.

chart—a collection of healthcare records relating to a single patient.

code—a standardized sequence of characters utilized for describing multiple, substantially identical, healthcare diagnoses and/or procedures.

communication—an exchange of information.

completion status—a measure of whether a task has been completed.

derive—obtain via determining, calculating, and/or looking-up.

display image—a visual rendering using an information device.

eHIM—an electronic HIM system.

electronic—digitally stored and/or transmitted.

element—a component of a user interface.

element set—a collection of user interface elements.

firmware—machine-readable instructions that are stored in a read-only memory (ROM). ROM's can comprise PROMs and EPROMs.

generator—a processor.

healthcare—goods and/or services provided to accommodate, maintain, and/or improve the physical, psychological, emotional, neurological, and/or cognitive health of a human and/or limitations thereto. Examples of healthcare include medical care, dental care, vision care, psychological care, physical therapy, speech therapy, occupational therapy, etc.

Health Information Management (HIM)— a process for administering and/or utilizing patient healthcare data.

HIPAA—Health Insurance Portability and Accountability Act of 1996, including any amendments or successors thereto.

information—data.

information device—a device capable of processing information, such as any general purpose and/or special purpose computer, such as a personal computer, workstation, server, minicomputer, mainframe, supercomputer, computer terminal, laptop, wearable computer, personal digital assistant, and/or phone, etc.

input—a signal, data, and/or information provided to a processor.

interface—(n.) a boundary across which two independent systems meet and act on or communicate with each other. (v.) to connect with or interact with by means of an interface.

healthcare record—a compilation of information in non-volatile storage.

memory—a hardware element capable of data storage, such as for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc.

metric—a calculated and/or measured value.

network—a coupling of two or more information devices for sharing resources (such as printers or CD-ROMs), exchanging files, or allowing electronic communications therebetween. Information devices on a network can be physically and/or communicatively coupled via various wireline or wireless media, such as cables, telephone lines, power lines, optical fibers, radio waves, microwaves, ultra-wideband waves, light beams, etc.

network interface—a device, system, or subsystem capable of coupling an information device to a network. For example, a network interface can be a telephone, cellular phone, cellular modem, telephone data modem, fax modem, wireless transceiver, ethernet card, cable modem, digital subscriber line interface, bridge, hub, router, or other similar device.

note—a written description.

patient—one who is scheduled to, has been admitted to, or has received, health care.

processor—a device and/or set of machine-readable instructions for performing a task. A processor comprises any one or combination of hardware, firmware, and/or software. A processor acts upon information by manipulating, analyzing, modifying, converting, transmitting the information for use by an executable procedure and/or an information device, and/or routing the information to an output device.

render—make perceptible to a human, for example as data, commands, text, graphics, audio, video, animation, and/or hyperlinks, etc., such as via any visual and/or audio means, such as via a display, a monitor, electric paper, an ocular implant, a speaker, a cochlear implant, etc.

repository—a memory and/or a database.

server—an information device and/or software that provides some service for other connected information devices via a network.

user interface—a tool and/or device for rendering information to a user and/or requesting information from the user. A user interface includes at least one of textual, graphical, audio, video, animation, and/or haptic elements.

### DETAILED DESCRIPTION

Existing applications fail to provide a consolidated and integrated application comprising a single, integrated, measurable system. Currently, approximately 80% of hospitals use a paper-based system to accomplish the tasks that a system according to invention principles automatically performs. Certain exemplary embodiments comprise a system that provides an integrated electronic Healthcare Information Management system. The system provides secure clinical and financial information management and workflow control via a user friendly display interface. The system address the administrative burdens and cost associated with existing disparate non-integrated processes. The system advantageously accelerates collection of revenue by reducing functional cycle times for key workflows and reduces expenses and errors. The system provide immediate, concurrent access to HIM electronic documents and information and increases physician and staff affinity by providing a virtual (remote access) environment for completion of administrative, compliance and revenue related tasks.

The system advantageously allows health systems to create a paperless, virtual, measurable Health Information Management (HIM) environment called eHIM herein. eHIM does this by creating an integrated HIM workflow that incorporates the major functions of the HIM department as they relate to revenue collection for a health system. eHIM combines a variety of services, tools, technologies, applications, and/or integration techniques to create a single solution that consolidates numerous HIM functions: Electronic Chart Assembly (Online Healthcare record), Deficiency Management, Completion Management, Coding Management, Coding, Abstracting, HIPAA Disclosure, and/or Release of Information. eHIM automates and integrates the major revenue related functions of the HIM department. eHIM consolidats multiple disparate functions into a single integrated system providing access to information and work flow systems virtually and remotely and eliminates burdensome manual paper based processing

eHIM may be deployed as a single system, or as individual components for Enterprise Document Management, Online Healthcare Record, Online Financial Record, Record Assembly, Deficiency and Completion Management, Coding Management, Disclosure Management, and/or Releases of Information. eHIM is utilized in an HIM department to improve revenue, reduce expense, reduce staff turnover, improve physician affinity, reduce errors, and/or meet regulatory statutes.

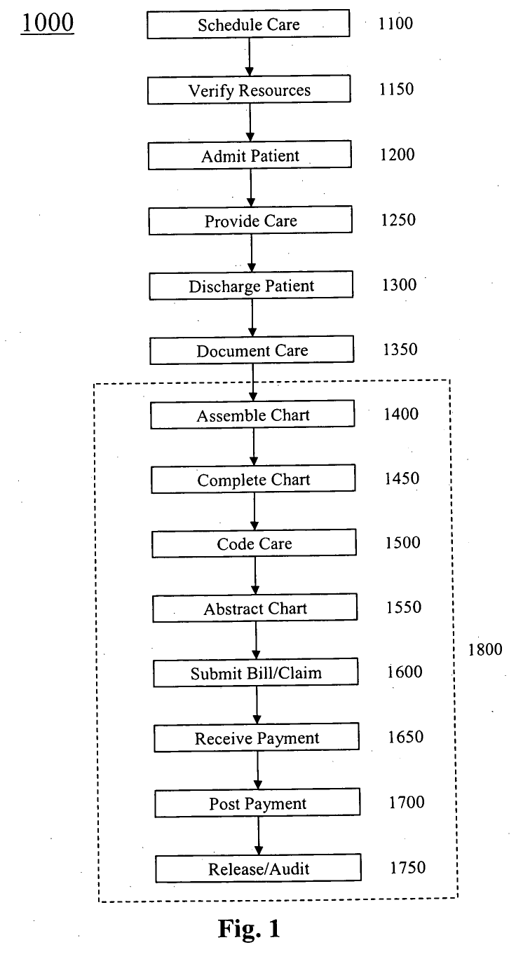

FIG. 1 is a flow chart of an exemplary embodiment of a method 1000. At activity 1100, health care for a patient is scheduled. At activity 1150, resources that might be utilized to provide the scheduled health care are verified. At activity 1200, the patient is admitted to a health care facility. At activity 1250, the patient is provided health care. At activity 1300, the patient is discharged. At activity 1350, the health care provided to the patient is documented.

At activity 1400, a chart describing the documented health care is assembled. At activity 1450, the chart is completed. At activity 1500, the provided health care is coded for reporting, insurance submission, billing, and/or management purposes. At activity 1550, the chart is abstracted. At activity 1600, a bill and/or claim is submitted. At activity 1650, payment of the bill and/or claim is received. At activity 1700, payment is posted, such as to an account associated with the patient, health care facility, health care provider(s), etc. At activity 1750, charges for the health care are released and/or audited.

eHIM provides an automatically integrated and/or consolidated workflow 1800 comprising two or more of activities 1400 through 1750, all of activities 1400 through 1750. Optionally, eHIM comprises activity 1200.

Using an Electronic Healthcare Record as a basis for capturing, digitizing, storing, and/or managing information (such as paper-recorded information), eHIM workflow software optimizes the processes listed above. Each process outputs specific data to a Decision Support/Data Warehouse engine, which is used to create an Executive Scorecard. The resulting information in the Executive Scorecard is used to measure performance within each process and/or measure the impact that each process has on key metrics such as hospital revenue.

Data is consolidated into a single system rather than multiple system. Reporting is executed from a single system rather than multiple systems. Data is synchronized with external systems such as Patient Accounting, hence potentially eliminating disparities in data measurement across departments. Data is collected electronically, rather then manually as in paper based systems. Data across multiple HIM processes is displayed and manipulated on one screen or set of screens rather than on multiple disparate applications. Data is used to collectively to measure HIM impact on productivity, revenue, and/or other metrics. Data is consolidated and/or consistently reported up to a single Director or Executive level using one system. Data is matched to external metrics such as overall hospital revenue.

eHIM provides automated data collection from multiple processes, a single collection point for data, the ability to view data from multiple processes across and/or side-by-side, consolidation of data with data gathered externally to the HIM department (Revenue, case mix, DRG, etc.), and/or a snapshop of desired metrics, such as HIM impact on overall revenue.

Data collected by the HIM workflow processes is stored initially in the Online Healthcare Record infrastructure of eHIM. From there, the data is exported to the Decision Support database of the Executive Score system of eHIM. Data collected from non HIM systems is initially stored by those source systems and then exported to Decision Support database of the Executive Score system.

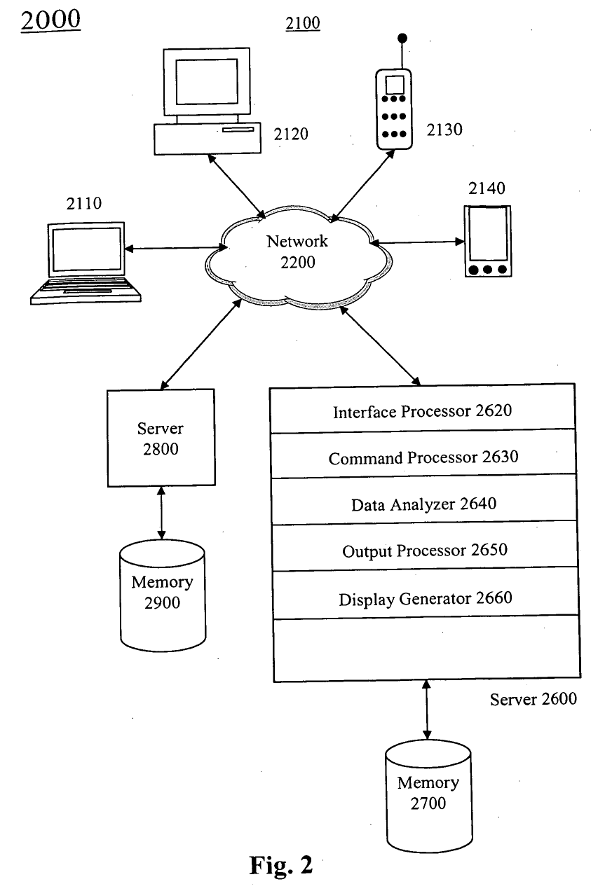

FIG. 2 is a block diagram of an exemplary embodiment of a system 2000, which comprises at least one information device 2100. At least one information device 2100 comprises at least of a variety of information devices 2110, 2120, 2130, 2140. At least one information device 2100 is coupled via a communication network 2200 to a health care information management server 2600, which comprises at least two of an interface processor 2620, a command processor 2630, a data analyzer 2640, an output processor 2650, and a display generator 2660. Coupled to server 2600 is a memory 2700. Coupled to network 2200 is a patient healthcare record server 2800, to which a memory 2900 is coupled.

Interface processor 2620 automatically electronically acquires information for use in identifying completion status of a plurality of electronic patient healthcare records of a corresponding plurality of different patients. Interface processor 2620 automatically electronically acquires billing information for healthcare services provided to patients. Interface processor 2620 automatically electronically acquires information indicating whether the electronic patient healthcare records contain appropriate healthcare procedure or diagnostic codes. Interface processor 2620 automatically electronically acquires information indicating whether the electronic patient healthcare records contain completed notes concerning patient treatment. Interface processor 2620 automatically electronically acquires information for use in identifying completion status of a plurality of electronic patient healthcare records of a corresponding plurality of different patients. Interface processor 2620 automatically stores the acquired information in a database. Interface processor 2620 automatically acquires the information for storage in a database by at least one of: (a) automatically intermittently interrogating an electronic patient record repository, and (b) automatically intermittently receiving the information from an electronic patient record repository management system.

Command processor 2630 receives a user command entered via a displayed image to access patient healthcare record processing information.

Data analyzer 2640 analyzes, possibly in response to a user command and/or a signal from command processor 2630, acquired information to derive data indicating: a first number of electronic patient healthcare records to be updated in response to events occurring during a predetermined time period, and status of a second number of the electronic patient healthcare records as being complete and/or incomplete. Data analyzer 2640 analyzes acquired information to derive data reflective of delay in billing for healthcare services provided to patients resulting from incomplete electronic patient healthcare records. Data analyzer 2640 analyzes acquired information to derive data indicating at least one of: (a) a number of bills not generated within a predetermined time duration resulting from delay in completing the electronic patient healthcare records, (b) an estimated cost per record associated with bills not generated within a predetermined time duration resulting from delay in completing the electronic patient healthcare records, and (c) a billing cost associated with delay in completing an individual record. Data analyzer 2640 analyzes acquired information to derive data indicating a number of the electronic patient healthcare records identified as being incomplete due to lack of the codes. Data analyzer 2640 analyzes acquired information to derive data indicating a number of the electronic patient healthcare records identified as being incomplete due to lack of completed notes. Data analyzer 2640 analyzes acquired information to derive data indicating at least one of, (a) a cost per an individual one of the electronic patient healthcare records resulting from delay in completion of some of the electronic patient healthcare records, (b) an error rate or error proportion associated with the electronic patient healthcare records resulting from delay in completion of some of the electronic patient healthcare records, and (c) a delinquency rate or delinquency proportion associated with the electronic patient healthcare records resulting from delay in completion of some of the electronic patient healthcare records. Data analyzer 2640 analyzes acquired information to derive data indicating at least one of, (a) a processing time per an individual one of the electronic patient healthcare records resulting from delay in completion of some of the electronic patient healthcare records, (b) an alert message to a user associated with delay in completion of some of the electronic patient healthcare records, and (c) a delinquency rate or delinquency proportion associated with the electronic patient healthcare records resulting from delay in completion of some of the electronic patient healthcare records required to support HIPAA compliant Disclosure and Release of Information.

Output processor 2650 processes derived data to be suitable for communication, such as communication to a display processor for processing for presentation in a display image to a user.

Display generator 2660 initiates generation of data representing a display image incorporating the derived data. Display generator 2660 initiates generation of data representing a composite display image incorporating the derived data together with healthcare record information of a particular patient.

The electronic patient healthcare records comprise electronic patient healthcare chart information. The predetermined time period comprises an hour, a shift, a day, a week, a four-week period, a month, a three month period, a quarter, and/or a year.

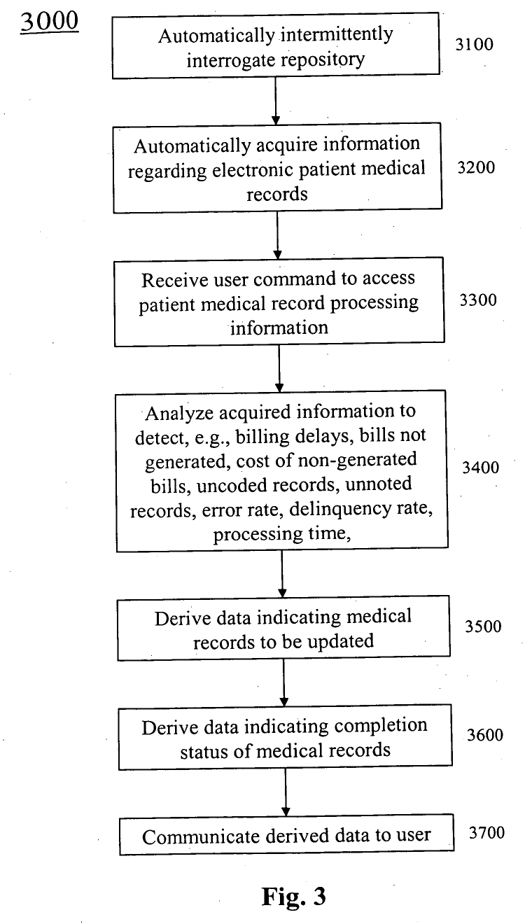

FIG. 3 is a flow chart of an exemplary embodiment of a method 3000. At activity 3100, eHIM automatically intermittently interrogates a repository comprising information regarding electronic patient healthcare records, the information collected from individual HIM workflows. At activity 3200, eHIM automatically acquires information regarding electronic patient healthcare records. At activity 3300, eHIM receives a user command to access electronic patient healthcare record processing information. At activity 3400, eHIM analyzes the acquired information to detect various metrics, such as status, count, time, rate, ratio, and/or percentage, etc., for performance categories such as productivity, quality, errors, delinquencies, cost, revenue, and/or profit, etc., for such HIM items as record processing, record coding, record miscoding, record noting, billing, bill generation, and/or bill payment, etc. At activity 3500, eHIM derives data indicating healthcare records to be updated and/or performance metrics. At activity 3600, eHIM derives data indicating a completion status of healthcare records. At activity 3700, eHIM communicates derived data and/or performance metrics to a user.

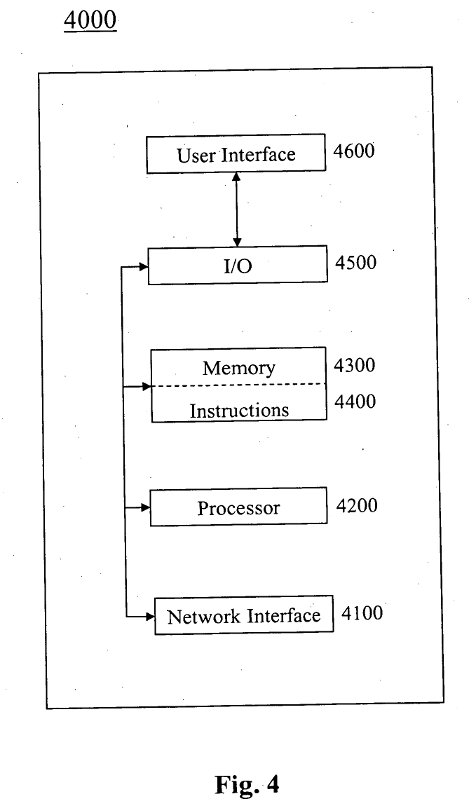

FIG. 4 is a block diagram of an exemplary embodiment of an information device 4000, which can represent any of information device(s) 2100, and/or servers 2600, 2800 of FIG. 2. Information device 4000 includes any of numerous well-known components, such as for example, one or more network interfaces 4100, one or more processors 4200, one or more memories 4300 containing instructions 4400, and/or one or more input/output (I/O) devices 4500, etc. Via one or more I/O devices 4500, a user interface 4600 is provided.

Via one or more user interfaces 4600, patient healthcare data, information, records, and/or charts are created, input, identified, searched, requested, provided, received, retrieved, revised, deleted, consolidated, and/or integrated, etc. Via one or more user interfaces 4600, one or more audit trails are created, input, identified, searched, requested, provided, received, retrieved, revised, and/or deleted. Via one or more user interfaces 4600, one or more reports of performance metrics (e.g., an eHIM scorecard) are created, input, identified, requested, searched, provided, rendered, received, retrieved, revised, and/or deleted. One or more processors, running on and/or via an information device 4000, provides any or all of these functions.

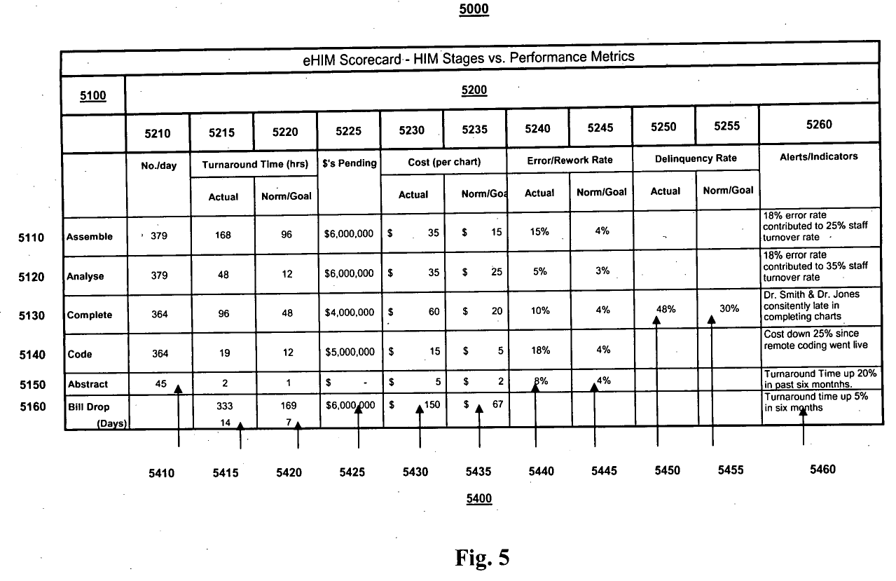

FIG. 5 is a model of an exemplary embodiment of a user interface 5000, which comprises an eHIM scorecard that reports HIM stages vs. Metrics, such as Performance Metrics. As illustrated, user interface 5000 comprises a number of HIM processing stages 5100, such as Assemble 5110, Analyze 5120, Complete 5130, Code 5140, Abstract 5150, and/or Bill Drop 5160. User interface 5000 comprises a number of patient healthcare record processing performance metric descriptors 5200, such as count of records processed per predetermined time period 5210 (i.e., record processing rate), actual record processing turnaround time 5215 (measured in a predetermined time unit), target record processing turnaround time 5220 (measured in a predetermined time unit), revenue value 5225 of pending records, actual cost per record processed 5230, target cost per record processed 5235, actual record processing error rate and/or rework rate 5240, target record processing error rate and/or rework rate 5245, actual record processing delinquency rate 5250, target record processing delinquency rate 5255, and/or record processing alert and/or indicator 5260. Note that a patient healthcare record processing performance metric descriptor is expressed as any of an actual, historical, statistical (e.g., minimum, maximum, average, median, mode, norm, target, and/or goal) value. At an intersection of any selected HIM processing stage 5100 and any selected patient healthcare record processing performance metric descriptor 5200 is a patent healthcare record processing performance metric 5400, such as a number 5410 of abstract processed per day, an actual bills dropped turn-around time 5415, a target, norm, and/or goal for bills dropped turn-around time 5420, a dollar value 5425 of bills dropped. (i.e., uncollected revenues), an actual cost 5430 of a dropped bill, a target cost 5435 of a dropped bill, an actual error rate 5440 of an abstracted patient healthcare record, a target error rate 5445 of an abstracted patient healthcare record, an actual delinquency rate 5450 of completed patient healthcare record chart, a target delinquency rate 5455 of completed patient healthcare record chart, and/or a bill drop alert and/or indicator 5460, etc. Via one or more processors associated with an information device, such as data analyzer 2640 of FIG. 2, a patent healthcare record processing performance metric 5400 is derived and/or calculated from patient healthcare data, information, records, and/or charts for any of one or more HIM processing stages 5100, processes, workflows, healthcare organizations, healthcare facilities, time periods, departments, teams, staffs, and/or individuals, etc.

The eHIM scorecard comprises external performance metrics such as HIM related patient accounting data from a Patient Accounting system, such as revenue; HIM related patient management data from a Patient Management system, such as Case Mix data; and/or Expense data from resource management systems, such as employee's wages and material costs.

Thus, the eHIM scorecard reports performance metrics of HIM processes, staff, and/or workflows. The eHIM scorecard reports a consolidation of HIM data, matched against itself, and/or against external metrics of interest.

Still other embodiments will become readily apparent to those skilled in this art from reading the above-recited detailed description and drawings of certain exemplary embodiments.

What is claimed is:

1. A healthcare information management system, comprising:
an interface processor for automatically electronically acquiring information for use in identifying completion status of a plurality of electronic patient healthcare records of a corresponding plurality of different patients;
a data analyzer for analyzing said acquired information to derive data indicating:
(a) a first number of electronic patient healthcare records to be updated in response to events occurring during a predetermined time period, and
(b) a status of a second number of said electronic patient healthcare records as being: (i) complete or (ii) incomplete; and
an output processor for processing said derived data to be suitable for communication.

2. A system according to claim 1, wherein
said output processor processes said derived data to be suitable for communication to a display processor for processing for presentation in a display image to a user.

3. A system according to claim 1, wherein
said interface processor automatically electronically acquires billing information for healthcare services provided to patients; and
said data analyzer analyzes said acquired information to derive data reflective of delay in billing for healthcare services provided to patients resulting from incomplete electronic patient healthcare records.

4. A system according to claim 3, wherein
said data analyzer analyzes said acquired information to derive data indicating at least one of: (a) a number of bills not generated within a predetermined time duration resulting from delay in completing said electronic patient healthcare records, (b) an estimated cost per record associated with bills not generated within a predetermined time duration resulting from delay in completing said electronic patient healthcare records, and (c) a billing cost associated with delay in completing an individual record.

5. A system according to claim 1, wherein
said predetermined time period comprises at least one of, (a) a day, (b) a week, (c) a month, (d) a three month period, and (e) a year.

6. A system according to claim 1, wherein
said interface processor automatically electronically acquires information indicating whether said electronic patient healthcare records contain appropriate healthcare procedure or diagnostic codes; and
said data analyzer analyzes said acquired information to derive data indicating a number of said electronic patient healthcare records identified as being incomplete due to lack of said codes.

7. A system according to claim 1, wherein
said interface processor automatically electronically acquires information indicating whether said electronic patient healthcare records contain completed notes concerning patient treatment; and
said data analyzer analyzes said acquired information to derive data indicating a number of said electronic patient healthcare records identified as being incomplete due to lack of completed notes.

8. A system according to claim 1, wherein
said data analyzer analyzes said acquired information to derive data indicating at least one of, (a) a cost per an individual one of said electronic patient healthcare records resulting from delay in completion of some of said electronic patient healthcare records, (b) an error rate or error proportion associated with said electronic patient healthcare records resulting from delay in completion of some of said electronic patient healthcare records, and (c) a delinquency rate or delinquency proportion associated with said electronic patient healthcare records resulting from delay in completion of some of said electronic patient healthcare records.

9. A system according to claim 1, wherein
said data analyzer analyzes said acquired information to derive data indicating at least one of, (a) a processing time per an individual one of said electronic patient healthcare records resulting from delay in completion of some of said electronic patient healthcare records, (b) an alert message to a user associated with delay in completion of some of said electronic patient healthcare records, and (c) a delinquency rate or delinquency proportion associated with said electronic patient healthcare records resulting from delay in completion of some of said electronic patient healthcare records required to support HIPAA compliant Disclosure and Release of Information.

10. A system according to claim 1, wherein
said electronic patient healthcare records comprise electronic patient healthcare chart information.

11. A system supporting healthcare information management, comprising:
an interface processor for automatically electronically acquiring information for use in identifying completion status of a plurality of electronic patient healthcare records of a corresponding plurality of different patients;
a command processor for receiving a user command entered via a displayed image to access patient healthcare record processing information;
a data analyzer for analyzing, in response to said user command, said acquired information to derive data indicating:
(a) a first number of electronic patient healthcare records to be updated in response to events occurring during a predetermined time period and
(b) status of a second number of said electronic patient healthcare records as being at least one of: (i) complete and (ii) incomplete; and
a display generator for initiating generation of data representing a display image incorporating said derived data.

12. A system according to claim 11, wherein
said interface processor automatically stores said acquired information in a database.

13. A system according to claim 11, wherein
said interface processor automatically acquires said information for storage in a database by at least one of: (a) automatically intermittently interrogating an electronic patient record repository, and (b) automatically intermittently receiving said information from an electronic patient record repository management system.

14. A system according to claim 11, wherein
said display generator initiates generation of data representing a composite display image incorporating said derived data together with healthcare record information of a particular patient.

15. A method, comprising:
automatically electronically acquiring information for use in identifying completion status of a plurality of electronic patient healthcare records of a corresponding plurality of different patients;
receiving a user command to access patient healthcare record processing information;
analyzing, in response to said user command, said acquired information to derive data indicating:
(a) a first number of electronic patient healthcare records to be updated in response to events occurring during a predetermined time period and
(b) a status of a second number of said electronic patient healthcare records as being (i) complete or (ii) incomplete; and
initiating generation of a display image comprising said derived data.

16. A user interface, comprising:
a predetermined plurality of patient healthcare record processing performance metric descriptors, an individual one of said predetermined plurality of patient healthcare record processing performance metric descriptors corresponding to an individual one of a predetermined plurality of health information management processing stages for a plurality of patient healthcare records, said predetermined plurality of health information management processing stages comprising at least coding and bill submission, said predetermined plurality of patient healthcare record processing performance metric descriptors comprising at least a record processing count and a record processing rate; and
a plurality of patient healthcare record processing performance metrics, an individual one of said patient healthcare record processing performance metrics corresponding to a selected one of said plurality of patient healthcare record processing performance metric descriptors and a selected one of said plurality of health information management processing stages.

17. A user interface according to claim 16, wherein said predetermined plurality of patient healthcare record processing performance metric descriptors further comprises a record processing time.

18. A user interface according to claim 16, wherein said predetermined plurality of patient healthcare record processing performance metric descriptors further comprises a record processing goal.

19. A user interface according to claim 16, wherein said predetermined plurality of patient healthcare record processing performance metric descriptors further comprises a record processing delinquency rate.

20. A user interface according to claim 16, wherein said predetermined plurality of patient healthcare record processing performance metric descriptors further comprises a record processing alert.

21. A user interface according to claim 16, wherein said predetermined plurality of patient healthcare record processing performance metric descriptors further comprises a record processing error rate.

22. A user interface according to claim 16, wherein said predetermined plurality of patient healthcare record processing performance metric descriptors further comprises a record processing cost.

23. A user interface according to claim 16, wherein said predetermined plurality of patient healthcare record processing performance metric descriptors further comprises a record processing revenue value.

24. A user interface according to claim 16, wherein said predetermined plurality of health information management processing stages further comprises at least one of assembly, analysis, completion, and abstracting.
